(19) United States
(12) Patent Application Publication
(10) Pub. No.: US 2025/0170545 A1
(43) Pub. Date: May 29, 2025

(54) SYNGAS CONDITIONING

(71) Applicant: ThermoChem Recovery International, Inc., Baltimore, MD (US)

(72) Inventor: Ravi Chandran, Baltimore, MD (US)

(21) Appl. No.: 18/961,084

(22) Filed: Nov. 26, 2024

Related U.S. Application Data
(60) Provisional application No. 63/603,112, filed on Nov. 27, 2023.

(51) Int. Cl. B01J 8/18; B01J 8/24; C01B 3/38; C01B 3/56; C10J 3/56

(52) U.S. Cl. CPC B01J 8/1827; B01J 8/24; C01B 3/38; C01B 3/56; C10J 3/56; C01B 2203/0227; C01B 2203/042; C01B 2203/0485; C01B 2203/1235; C10J 2200/06

(57) ABSTRACT

This disclosure describes systems and methods for processing raw syngas with in-situ catalyst regeneration.

### CROSS-REFERENCE TO RELATED APPLICATION

This application claims the benefit of U.S. Patent Application No. 63/603,112 filed on Nov. 27, 2023, which is incorporated herein by reference in its entirety.

### TECHNICAL FIELD

This invention relates to systems and methods for processing raw syngas with in-situ catalyst regeneration.

### BACKGROUND

The use of syngas from the gasification of carbonaceous feedstocks is of interest for advanced energy generation and the production of alternative fuels and chemicals.

### SUMMARY

This disclosure describes systems and methods for processing raw syngas with in-situ catalyst regeneration, including chlorine species capture using a first sorbent, syngas desulfurization using a first catalyst, sulfur species capture using a second sorbent, and catalytic hydrocarbon reforming. Some systems and methods include nitrogen species decomposition.

### BRIEF DESCRIPTION OF DRAWINGS

FIG. 1 is a schematic depicting a first embodiment of warm gas cleanup and catalytic hydrocarbon reforming of raw syngas.

FIG. 2 is a schematic depicting a second embodiment of warm gas cleanup and catalytic hydrocarbon reforming of raw syngas.

FIG. 3 is a schematic depicting a first embodiment of a sulfur species capture and catalytic hydrocarbon reforming unit.

FIG. 4 is a schematic depicting a second embodiment of a sulfur species capture and catalytic hydrocarbon reforming unit.

FIG. 5 is a schematic depicting a first embodiment of an integrated biorefinery with a two-stage gasification system.

FIG. 6 is a schematic depicting a second embodiment of an integrated biorefinery with a two-stage gasification system.

FIG. 7 is a schematic depicting a third embodiment of an integrated biorefinery with a two-stage gasification system.

### DETAILED DESCRIPTION

This disclosure describes systems and methods for processing raw syngas with in-situ catalyst regeneration, including chlorine species capture using a first sorbent, syngas desulfurization using a first catalyst, sulfur species capture using a second sorbent, and catalytic hydrocarbon reforming. Some systems and methods include nitrogen species decomposition. As described herein, raw syngas typically contains H₂, CO, CO₂, H₂O, CH₄, other hydrocarbons CₓH_{y} including tars (benzene, toluene, xylene, naphthalene, indene, etc.), unreacted carbon and ash (or char), and may contain contaminants such as H₂S, COS, NH₃, HCN, HCl, organic chlorine, sulfur and nitrogen compounds, fine particulates, and metal vapors (Hg, As, etc.). Other components may be present in raw syngas, such as volatile organic compounds (VOCs) or aromatics including one or more of benzene, toluene, phenol, styrene, xylene, and cresol; as well as semi-volatile organic compounds (SVOCs) or polyaromatics, such as one or more of indene, indane, napthalene, methylnapthalene, acenapthylene, acenapthalene, anthracene, phenanthrene, (methyl-) anthracenes/phenanthrenes, pyrene/fluoranthene, methylpyrenes/benzofluorenes, chrysene, benz[a]anthracene, methylchrysenes, methylbenz[a]anthracenes, perylene, benzo[a]pyrene, dibenz[a,kl]anthracene, and dibenz[a,h]anthracene.

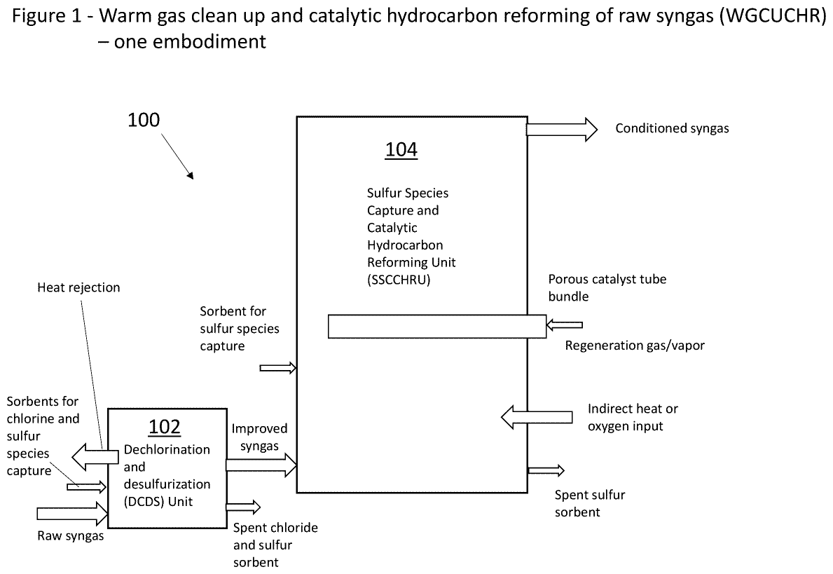

FIG. 1 is a schematic depicting system 100 for generating conditioned syngas from raw syngas. The raw syngas may be provided to system 100 from a single stage or multi-stage (e.g., two-stage gasifier). Raw syngas can be generated by a gasifier, such as by way of steam reforming or in a steam reformer. Further syngas can be generated by a differing gasifier, such as by way of converting char or in a carbon trim cell (CTC).

System 100 utilizes sorbents and catalysts to perform sorption, reactive adsorption, decomposition, hydrogenation, cracking, and reforming of raw syngas to generate conditioned syngas with minimal contaminants, tars, methane, and other hydrocarbons and increased H₂ and CO content. System 100 includes a capture unit (e.g., dechlorination and desulfurization unit (DCDSU) 102) and a catalytic hydrocarbon reforming unit (e.g., sulfur species capture and catalytic hydrocarbon reforming unit (SSCCHRU) 104).

Any initial gas may be provided to the capture unit or the catalytic hydrocarbon reforming unit. For instance, raw syngas or a combination of raw syngas and a char-converted product gas (e.g., such as a CTC product gas) can be provided as an initial gas to the capture unit. In some cases (e.g., if dechlorination is unnecessary for the char-converted product gas), the char-converted product gas can be provided directly to the catalytic hydrocarbon reforming unit.

Turning again to FIG. 1, DCDSU 102 may be a fixed bed or fluidized bed or entrained flow unit, with reactor type selection based at least in part upon the chlorine species, sulfur species (especially organic sulfur), and nitrogen species (especially organic nitrogen) content in the raw syngas. A fixed bed with relatively large sorbent and catalyst particles (e.g., 1 to 10 mm) may be preferable if the chlorine content is very low (e.g., <10 ppmv) and organic sulfur content is very low (e.g., <2 ppmv) in the syngas. In other cases, a fluidized bed or entrained flow reactor with cyclone(s) may be preferable. For fluidized bed and entrained flow reactors, fresh sorbent for chlorine species capture, an optional nickel or palladium catalyst for promoting the formation of HCl from organic chlorine species and NH₃ from organic nitrogen species, and fresh or regenerated catalyst for desulfurization is added, and spent sorbent and catalyst is discharged.

For fluidized bed reactors, the bed material may either be the first sorbent and first catalyst or a combination of these with engineered particles such as alumina bubbles, ceramic bubbles, ceramic spheres, titanate particles, silica sand, lime, dolomite, olivine sand, etc. Examples of suitable particle sizes include coarse (e.g., 1 to 10 mm) for fixed bed, granular (e.g., 100 to 1,000 microns) for a fluidized bed, and (e.g., <150 microns) for entrained flow reactor.

The raw gas inlet temperature in DCDSU 102 may vary depending upon the feedstock and gasifier type. As such, in some cases, a heat exchanger may be included to transfer heat from the DCDSU and to maintain the optimum temperature for the reactions. Upon removal of contaminants by the DCDSU, an improved syngas can be generated. In some embodiments, the improved syngas is characterized by decreased chlorine content and/or decreased organic sulfur and/or organic nitrogen content, as compared to the raw syngas.

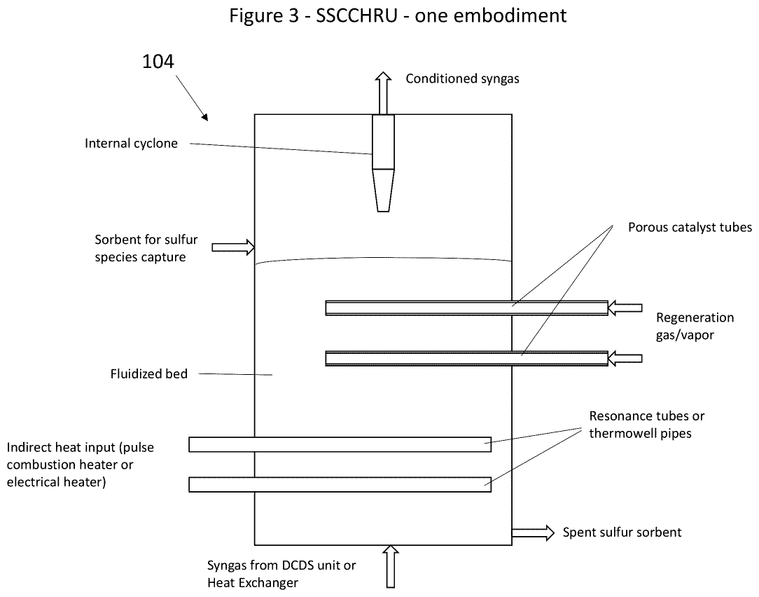

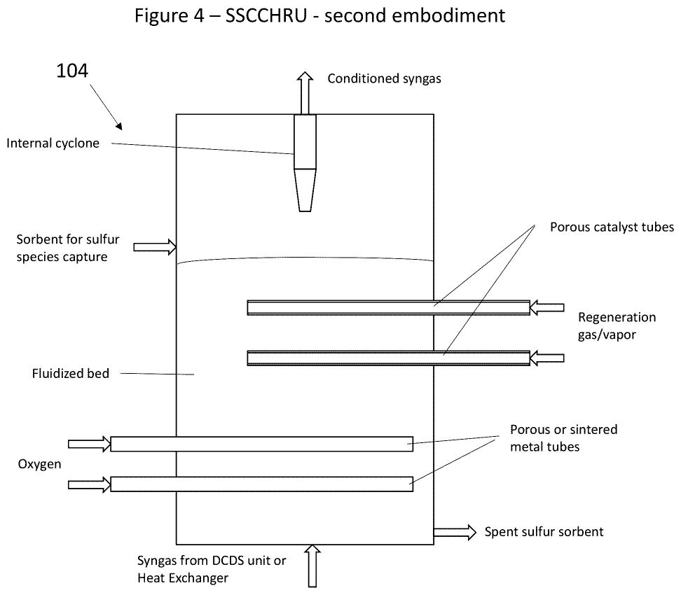

In SSCCHRU 104, one or more catalytic elements may be present to crack and/or reform tar or hydrocarbon in the improved syngas provided by the DCDSU 102. The catalytic element can include a structure-supported catalyst. For example, the catalytic element can include a porous catalyst tube. A plurality of catalytic elements may be present (e.g., a plurality of porous catalyst tubes or a porous catalyst tube bundle). Regeneration fluid (e.g., as a gas or vapor) can be provided through the structure (e.g., a tube structure) to regenerate the catalyst. Additional details are provided in FIGS. 3 and 4.

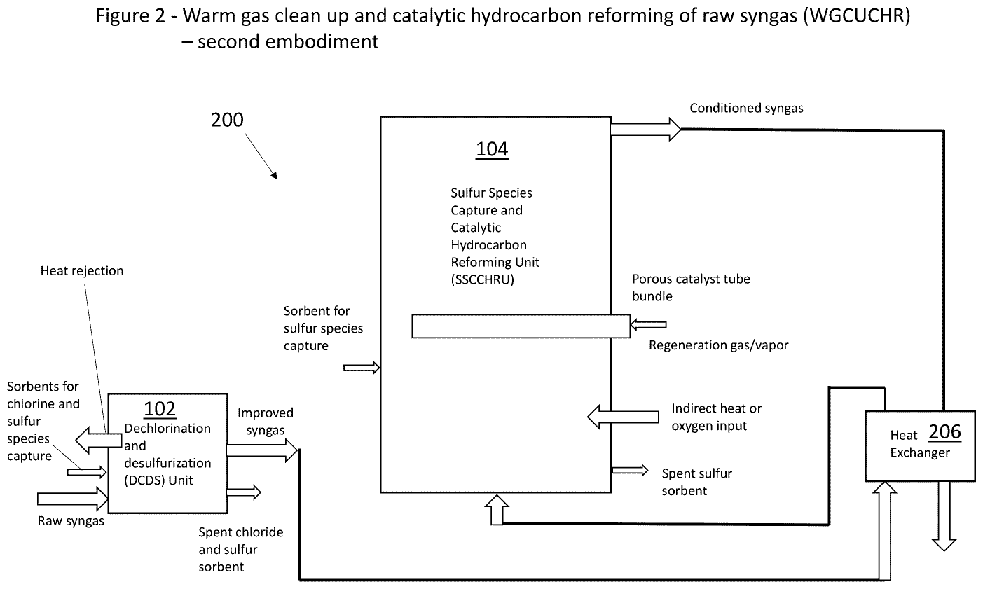

FIG. 2 is a schematic depicting system 200 for generating conditioned syngas from raw syngas. System 200 includes DCDSU 102, SSCCHRU 104, and heat exchanger 206. Heat exchanger 206 is configured to recover heat from the conditioned syngas and preheat the intermediate syngas (e.g., improved syngas).

FIG. 3 is a schematic depicting an embodiment of SSCCHRU 104 configured to operate in a fluidized bed mode with an internal cyclone. In SSCCHRU 104, a second sorbent, which can be specific to sulfur species capture, is provided, and spent sorbent is discharged. The fluidized bed material may either be the second sorbent or a combination of second sorbent and engineered particles such as alumina bubbles, ceramic bubbles, ceramic spheres, titanate particles, silica sand, lime, dolomite, olivine sand, etc. Examples of suitable particle sizes range from 100 to 600 microns in sauter mean diameter, and preferably between 200 and 450 microns. Catalytic elements (e.g., catalytic tubes) are utilized in the fluidized bed to crack and reform tars and hydrocarbons in the syngas. The sulfur sorbent particles capture sulfur contaminants in the syngas and inhibit or prevent catalyst deactivation due to sulfidation.

In some embodiments, the catalytic element can include a structure configured to allow a regeneration fluid to pass therethrough; at least one catalyst supported on a portion of an external surface of the structure; and one or more internal channels configured to deliver the regeneration fluid to the external surface of the structure to regenerate the at least one catalyst. As described herein, in some examples, the structure can include an elongated tube, which in turn can be formed from a porous material. In use, a regeneration fluid (e.g., a vapor or a gas) can be delivered through the structure and to the catalyst, thereby refreshing or regenerating the catalyst.

The reforming process is endothermic and thus requires heat input to maintain the fluidized bed temperature. As depicted in FIG. 3, the reactor may be heated indirectly using either pulse combustion heat exchangers or electrical heaters. The porous catalyst tubes in SSCCHRU 104 are capable of in situ regeneration with any combination of oxygen/steam/CO₂ mixture or another oxidant source (e.g., air). Nitrogen species such as ammonia are decomposed to yield nitrogen and hydrogen. In some embodiments, as depicted in FIG. 4, oxygen (e.g., greater than 90% purity), is provided to SSCCHRU 104 to affect exothermic reactions. Oxygen can be provided in any useful manner, such as by use of porous or sintered metal tubes.

Suitable dechlorination catalysts are nickel or palladium based; suitable chloride sorbents, such as NaHCO₃, Na₂CO₃, and other commercially available sodium-based and other chloride sorbents. The NaHCO₃ may be in natural form (nahcolite) or spray dried or on a support. The Na₂CO₃ (or washing soda or soda ash) may be in the form of particles or on a support. Other sodium species may also be in the form of particles or on a support. Examples of suitable supports include inert materials such as alumina, titania, and ceria. Examples of suitable particle sizes include coarse (1 to 10 mm) for fixed bed, granular (100 to 1,000 microns) for a fluidized bed, and (<150 microns) for entrained flow reactor for chlorine species capture. Dechlorination leads to the conversion of organic chlorine species into HCl, and the chlorine capture is understood to proceed as follows. Sodium bicarbonate decomposes to sodium carbonate. The release of CO₂ and steam generates a porous and reactive first sorbent as shown in Eq. 1.

2NaHCO₃→Na₂CO₃+H₂O(g)+CO₂(g) (1)

The sodium carbonate also reacts with hydrogen chloride to form sodium chloride, as shown in Eq. 2.

Na₂CO₃+2HCl(g)→2NaCl+H₂O(g)+CO₂(g) (2)

The make-up or addition of sorbent may correspond to a molar ratio such as Na:Cl ranging from 1 to 10 (e.g., 1.5 to 5).

Suitable catalysts for organic sulfur species desulfurization include Ni₂P, CoMo, Mo, Co or NiMo or NiCoMo on a support such as alumina, titania, ceria, or silica. Other transition metal-based catalysts with or without promoters may also be used. The desulfurization includes conversion of organic sulfur species into H₂S. Desulfurization of organic species is understood to proceed as shown in Eqs. (3) and (4).

Organic S+H₂→CxHy+H₂S (3)

MₓO_{y}+xH₂S+(y−x)H₂→xMS+yH₂O (4)

The make-up or addition of catalyst may correspond to a molar ratio such as M:S between 0 and 10 (e.g., between 1 and 10) and in particular, between 0 and 5 (e.g., between 1 and 5). In certain cases, some H₂S may be captured rather than converted.

Suitable second sorbents for sulfur species capture include Mn metal oxide on a support such as gamma-alumina, titanate, etc.; CuO or Cu₂O with promoters such as Cr₂O₃ (to impede oxide reduction) on a support such as alumina, titanate, etc.; and zinc titanate with additives for attrition resistance. Other metal-based sorbents with or without promoters may also be used. The second sorbent is typically in granular form, with a particle size in a range of about 100 microns to about 1,000 microns. The make-up or addition of sorbent may correspond to a molar ratio such as M:S ranging from 0 and 10 (e.g., 1 and 10) and in particular, between 0 and 5 (e.g., 1 and 5). The sorbent process is understood to proceed as shown in Eq. 5.

MₓO_{y}+xH₂S+(y−x)H₂→xMS+yH₂O (5)

Denitrogenation leads to the conversion of organic nitrogen species such as acetonitrile and acrylonitriles into ammonia in the presence of nickel or palladium catalysts.

Catalyst tubes described herein include metal or ceramic porous tubular structures having an external catalyst surface with one or more internal channels suitable for delivery of a regeneration fluid (e.g., one or more of oxygen, steam, and carbon dioxide) to the catalyst. Suitable examples of catalyst tubes include alkaline earth metal hexa-aluminate (MeO·6Al₂O₃, where Me is an alkaline earth metal such as Ca, Mg, Ba, and Sr) porous support tube coated with one or more catalyst metals selected from Ni, Rh, Pt, Ir, Pd, Ru, and Re; catalyst may include molybdenum oxide or tungsten oxide or Ni₂P, CoMo, Mo, Co or NiMo or NiCoMo on a support such as alumina, titania, ceria, or silica. The coating may include Ni or NiO, with or without alkali-promotion. Other suitable examples of porous support tubes include gamma-alumina, MgO, CeO₂, TiO₂, monoclinic zirconia, yttria stabilized zirconia (YSZ), gadolinium-doped zirconia (Gd—Z), and sintered nickel tube such as Nickel 200. Catalytic steam reforming reaction will convert the hydrocarbons as shown in Eq. 6.

CₓH_{y}+(x+z)H₂O=(x−z)CO+zCO₂+(x+z+y/2)H₂ (6)

Decomposition of ammonia will yield nitrogen and hydrogen as shown in Eq. 7.

2NH₃=N₂+3H₂ (7)

Any of the various methods known in the art, such as deposition, dip coating, wash coating, spray coating, incipient wetness, sol-gel, precipitation, 3-D printing, or impregnation followed by calcination or partial or full thermal treatment may be used to prepare the sorbents, catalyst particles, and catalyst tubes.

Suitable operating temperatures for the first step or first reactor are typically in a range of 500° C. to 750° C. (e.g., 550° C. to 700° C.). Suitable operating temperatures for the second step or second reactor are typically in a range of 700° C. to 900° C. (e.g., 700° C. to 850° C.).

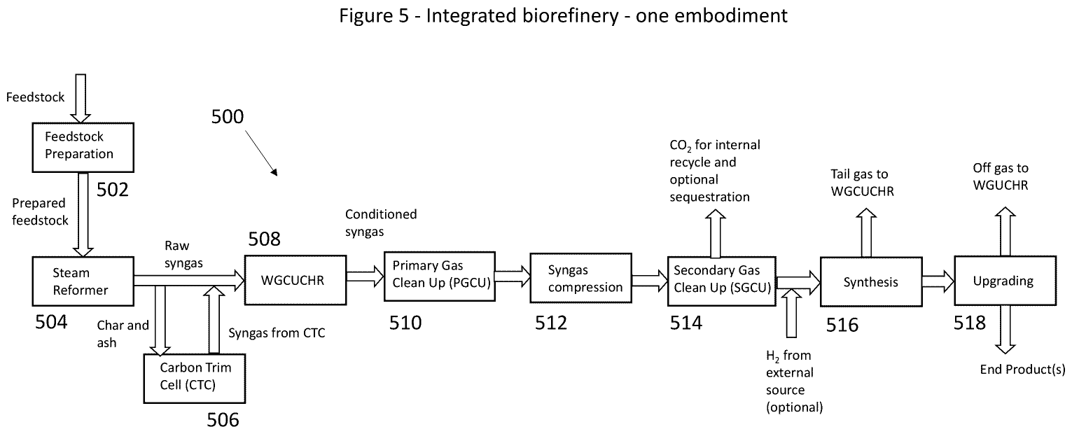

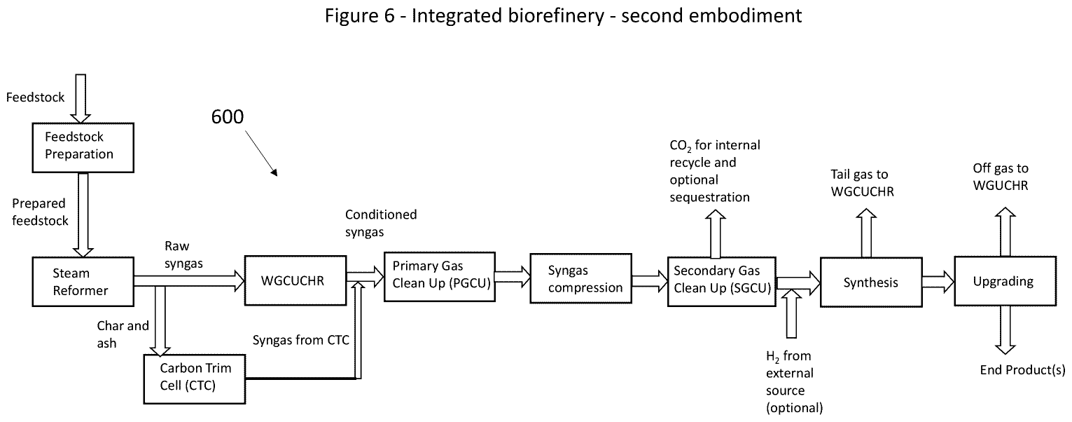

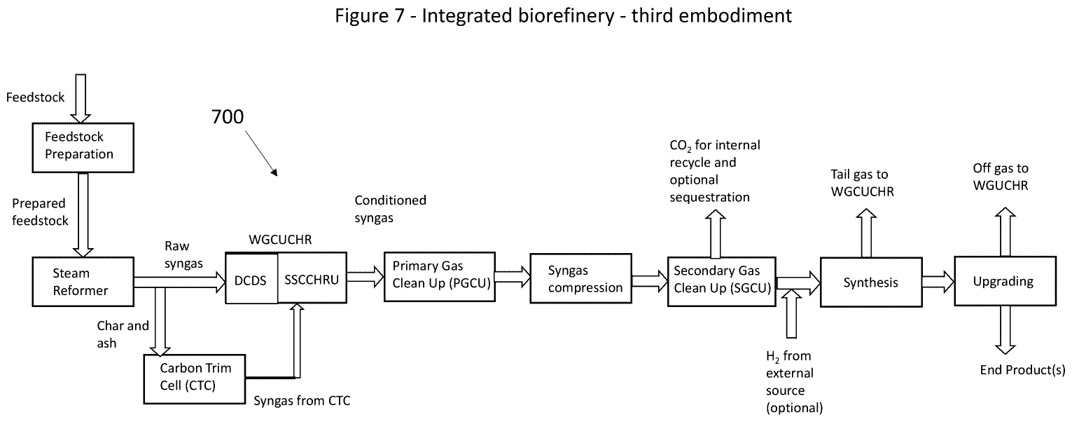

FIGS. 5, 6, and 7 are schematics depicting integrated biorefinery systems 500, 600, and 700, respectively, for two-stage gasification systems. Systems 500, 600, and 700 each include the following components: feedstock preparation unit 502, steam reformer 504, carbon trim cell (CTC) 506, warm gas cleanup and catalytic hydrocarbon reforming (WGCUCHR) unit 508 (which includes DCDSU 102 and SSCCHRU 104), primary gas cleanup (PGCU) unit 510, syngas compression unit 512, secondary gas cleanup (SGCU) unit 514, synthesis unit 516, and upgrading unit 518. Systems 500, 600, and 700 differ with respect to the routing of syngas from CTC 506.

Feedstock is provided to feedstock preparation unit 502. Suitable feedstock includes carbonaceous materials, including biomass or portions of municipal solid waste derived from biomass (e.g., sorted municipal solid waste). At least 60 wt %, at least 70 wt %, at least 80 wt %, at least 90 wt %, at least 95 wt %, or at least 99 wt % of carbon feedstock may be biomass or portions of municipal solid waste derived from biomass. Prepared feedstock from feedstock preparation unit 502 is provided to steam reformer 504, which converts the prepared feedstock to raw syngas, and includes char and ash. At least some of the raw syngas is provided to WGCUCHR unit 508 and conditioned to yield conditioned syngas. The conditioned syngas from WGCUCHR 508 is provided to PGCU unit 510. The PGCU may include heat recovery, particulate and other contaminant scrubbing, and optional CO₂ capture. Char and ash from steam reformer 504 is provided to CTC 506 and converted to syngas (e.g., a char-converted syngas).

In system 500, syngas from CTC 506 is combined with raw syngas from steam reformer 504, and the combined stream is provided to WGCUGHR unit 508. In system 600, syngas from CTC 506 is combined with conditioned syngas from WGCUGHR unit 508 and the combined stream is provided to PGCU unit 510. In system 700, syngas from CTC 506 is provided to SSCCHRU 104 in WGCUGHR unit 508.

From PGCU unit 510, the conditioned syngas is provided to syngas compression unit 512. Compressed syngas from syngas compression unit 512 is provided to SGCU unit 514. The SGCU may include syngas polishing (residual contaminants and metals capture to reduce the levels of these below 20 ppb) and CO₂ capture. At least some of the carbon dioxide from either PGCU 510 or SGCU unit 514 may be recycled or sequestered. Syngas from SGCU unit 514 is provided to synthesis unit 516 to provide one or more synthesis products. Optionally, H₂ from an external source may be provided to synthesis unit 516. Catalytic synthesis may be conducted in the synthesis unit 516, such as Fischer-Tropsch (FT) synthesis. Non-limiting examples of synthesis products include one or more of Fischer-Tropsch products, tail gas, ethanol, mixed alcohols, methanol, dimethyl ether, and the like, as well as combinations of any of these. Tail gas from synthesis unit 516 may be recycled to WGCUCHR unit 508 either for conditioning or as fuel or both.

Output from synthesis unit 516 is provided to upgrading unit 518. End product(s) (e.g., upgraded products) are collected from upgrading unit 518. Non-limiting examples of upgraded products include one or more of liquid fuels, naphtha, off gas, jet fuels, renewable fuels, alcohols, dimethyl ether (DME), ethanol, gasoline, diesel, and the like, as well as combinations of any of these. In some embodiments, off gas from upgrading unit 518 may be recycled to WGCUCHR unit 508 either for conditioning or as fuel or both.

The systems and methods herein can be used to process one or more syngas products (e.g., raw syngas, char-converted product gas, etc.) to provide a conditioned syngas, which in turn can be used to produce or synthesize something from it. Normally, these can be categorized into systems that generate hydrogen, ethanol, mixed alcohols, methanol, dimethyl ether, chemicals or chemical intermediates (e.g., plastics, solvents, adhesives, fatty acids, acetic acid, carbon black, olefins, oxochemicals, ammonia, etc.), Fischer-Tropsch products (e.g., liquified petroleum gas, naptha, kerosene/diesel, lubricants, waxes), synthetic natural gas, or power (heat or electricity).

The systems and methods herein can be used to remove one or more undesirable syngas constituents, which can refer to any constituents present in syngas other than hydrogen (H₂) and carbon monoxide (CO). Non-limiting examples of undesirable syngas constituents include, but not limited to, carbon dioxide (CO₂), hydrocarbons, VOC, SVOC, chlorine species (e.g., chlorine-containing compounds, such as hydrogen chloride, chlorine gas, vinyl chloride, chlorobenzene, and the like), sulfur species (e.g., sulfur-containing compounds, such as hydrogen sulfide, carbonyl sulfide, thiophene, mercaptans, carbon disulfide, and the like), nitrogen species (e.g., nitrogen-containing compounds, such as ammonia, hydrogen cyanide, acetonitrile, acrylonitrile, and the like), as well as other impurities that are present in the feedstock that can form during thermochemical syngas generation processes. Hydrocarbons refer to organic compounds of hydrogen and carbon, CₓH_{y}. These may include, but not limited to methane (CH₄), ethane (C₂H₆), ethylene (C₂H₄), propane (C₃H₈), benzene (C₆H₆), etc. Hydrocarbons can include VOCs and SVOCs.

As used herein, an “improved syngas”, as well as variants thereof refer, to a syngas where at least one undesirable syngas constituent is removed and/or reduced.

As used herein, a “conditioned syngas”, as well as variants thereof refer, to a syngas where at least one undesirable syngas constituent is reformed and/or cracked to provide an increased amount of hydrogen (H₂) and/or carbon monoxide (CO).

Additional embodiments are described below.

Embodiment 1 is a system comprising:
a gasifier configured to provide an initial syngas stream;
a capture unit configured to receive the initial syngas stream, or a portion thereof, and yield an improved syngas stream having decreased chlorine content and/or decreased sulfur content, as compared to the initial syngas stream; and
a catalytic hydrocarbon reforming unit configured to receive the improved syngas stream, or a portion thereof, and yield a conditioned syngas stream.

The system of embodiment 11, wherein the gasifier comprises a single stage gasifier or a multi-stage gasifier (e.g., a two-stage gasifier).

The system of embodiment 1 or 22, wherein the capture unit comprises a fixed bed, a fluidized bed (e.g., an indirectly heated fluidized bed with an optional internal cyclone), or a flow reactor (e.g., an entrained flow reactor with an optional cyclone).

The system of any one of embodiments 1-33, wherein the capture unit further comprises a first catalyst with an optional engineered particle (e.g., an alumina bubble, a ceramic bubble, a ceramic sphere, a titanate particle, and the like).

The system of embodiment 44, wherein a fluidized bed material for the capture unit comprises the first catalyst, an engineered particle, a first sorbent (e.g., a sodium-based sorbent, a transition metal-based sorbent, and the like), or a combination of any of these.

The system of any one of embodiments 1-55, wherein the capture unit comprises a first sorbent to capture chlorine species and/or sulfur species (e.g., the first sorbent comprising a sodium-based sorbent, a transition metal-based sorbent, and the like).

The system of embodiment 66, wherein the capture unit further comprises an inlet configured to deliver the first sorbent to an interior of a reactor of the capture unit and an outlet configured to remove a first spent sorbent from the interior.

The system of any one of embodiments 1-77, wherein the capture unit is configured to operate at a temperature from about 500° C. to about 750° C.

The system of any one of embodiments 1-88, wherein the catalytic hydrocarbon reforming unit comprises a fluidized bed (e.g., an indirectly heated fluidized bed with an optional internal cyclone).

The system of any one of embodiments 1-99, wherein the catalytic hydrocarbon reforming further comprises an engineered particle (e.g., an alumina bubble, a ceramic bubble, a ceramic sphere, a titanate particle, and the like).

The system of embodiment 1010, wherein a fluidized bed material for the catalytic hydrocarbon reforming unit comprises the engineered particle, a second sorbent (e.g., a transition metal-based sorbent, a metal-based sorbent, and the like), or a combination of any of these.

The system of any one of embodiments 1-1111, wherein the catalytic hydrocarbon reforming unit comprises one or more catalytic elements configured to crack and/or reform tar or hydrocarbon in the improved syngas stream to yield hydrogen (H₂) and/or carbon monoxide (CO).

The system of embodiment 1212, wherein at least one of the one or more catalytic elements comprises:
a structure configured to allow a regeneration fluid to pass therethrough;
at least one catalyst supported on a portion of an external surface of the structure; and
one or more internal channels configured to deliver the regeneration fluid to the external surface of the structure to regenerate the at least one catalyst.

The system of embodiment 1313, wherein the at least one catalytic element is configured to contact the improved syngas stream to yield the conditioned syngas stream.

The system of embodiment 1313 or 1414, wherein the structure comprises an elongated tube.

The system of any one of embodiments 1313-1515, wherein the structure comprises a porous material.

The system of any one of embodiments 1313-1616, further comprising a manifold in fluidic communication with the one or more catalytic elements, and wherein the manifold is configured to receive the regeneration fluid and deliver the regeneration fluid to the one or more catalytic elements.

The system of any one of embodiments 1313-1717, wherein the regeneration fluid comprises a vapor or a gas.

The system of any one of embodiments 1313-1818, wherein the regeneration fluid comprises an oxidant (e.g., oxygen, steam, air, carbon dioxide, or a combination of any of these).

The system of any one of embodiment 1-1919, wherein the catalytic hydrocarbon reforming unit is configured to operate at a temperature from about 700° C. to about 900° C.

The system of any one of embodiment 1-2020, further comprising a pulse heater (e.g., a pulse combustion heat exchanger), an electric heater, or a heat exchanger configured to heat (e.g., indirectly heat) the catalytic hydrocarbon reforming unit or a portion thereof (e.g., a reactor of the catalytic hydrocarbon reforming unit).

The system of any one of embodiment 1-2121, further comprising an oxidant source (e.g., oxygen-containing gas, such as oxygen gas (O₂)) configured to be delivered to the catalytic hydrocarbon reforming unit or a portion thereof (e.g., a reactor of the catalytic hydrocarbon reforming unit).

The system of any one of embodiments 1-2222, wherein the catalytic hydrocarbon reforming unit comprises a second sorbent to capture sulfur species (e.g., the second sorbent comprising a transition metal-based sorbent, a metal-based sorbent, and the like).

The system of embodiment 2323, wherein the catalytic hydrocarbon reforming unit further comprises an inlet configured to deliver a second sorbent to an interior of the catalytic hydrocarbon reforming unit and an outlet configured to remove a second spent sorbent from the interior.

The system of any one of embodiments 11-2424, further comprising:
a heat exchanger configured to preheat the improved syngas and/or to recover heat from the conditioned syngas.

The system of any one of embodiments 11-2525, wherein the initial syngas stream comprises raw syngas, a char-converted product gas (e.g., a carbon trim cell product gas), or a combination thereof.

The system of any one of embodiments 1-2626, wherein the improved syngas stream comprises decreased chlorine content and decreased sulfur content, as compared to the initial syngas stream.

The system of any one of embodiments 1-2727, wherein the conditioned syngas stream comprises increased hydrogen (H₂) content and/or increased carbon monoxide (CO) content, as compared to the initial syngas stream.

The system of any one of embodiments 1-2828, wherein the conditioned syngas stream further comprises decreased nitrogen content and/or decreased sulfur content, as compared to the initial syngas stream or the improved syngas stream.

The system of any one of embodiments 1-2929, wherein the conditioned syngas stream further comprises decreased sulfur content, as compared to the improved syngas stream.

Embodiment 31 is a catalytic hydrocarbon reforming unit comprising:
a reactor (e.g., a fluidized bed reactor) configured to receive a first syngas stream (e.g., from a capture unit, such as any described herein, or a heat exchanger);
an optional cyclone disposed within an interior of the reactor;
a sorbent disposed within an interior of the reactor; and
one or more catalytic elements configured to contact the first syngas stream, or a portion thereof, to yield a conditioned syngas stream, wherein at least one of the one or more catalytic elements comprises:
   a structure configured to allow a regeneration fluid to pass therethrough;
   at least one catalyst supported on a portion of an external surface of the structure; and
   one or more internal channels configured to deliver the regeneration fluid to the external surface of the structure to regenerate the at least one catalyst.

The unit of embodiment 3131, wherein the at least one catalytic element is configured to contact the first syngas stream, or a portion thereof, to yield the conditioned syngas stream.

The unit of embodiment 31 or 32, wherein the structure comprises an elongated tube.

The unit of any one of embodiments 31-33, wherein the structure comprises a porous material.

The unit of any one of embodiments 31-34, further comprising:
a manifold in fluidic communication with the one or more catalytic elements, and
wherein the manifold is configured to receive the regeneration fluid and deliver the regeneration fluid to the one or more catalytic elements.

The unit of any one of embodiments 31-35, wherein the regeneration fluid comprises a vapor or a gas.

The unit of any one of embodiments 31-36, wherein the regeneration fluid comprises an oxidant (e.g., oxygen, steam, air, carbon dioxide, or a combination of any of these).

The unit of any one of embodiments 31-37, wherein the catalytic hydrocarbon reforming unit is configured to operate at a temperature from about 700° C. to about 900° C.

The unit of any one of embodiments 31-38, further comprising:
a pulse heater (e.g., a pulse combustion heat exchanger), an electric heater, or a heat exchanger configured to heat (e.g., indirectly heat) the catalytic hydrocarbon reforming unit or a portion thereof (e.g., the reactor of the catalytic hydrocarbon reforming unit).

The unit of any one of embodiments 31-39, further comprising:
an inlet configured to deliver an oxidant source (e.g., oxygen-containing gas, such as oxygen gas (O₂)) to the catalytic hydrocarbon reforming unit or a portion thereof (e.g., the reactor of the catalytic hydrocarbon reforming unit).

The unit of any one of embodiments 31-40, wherein the sorbent is configured to capture sulfur species (e.g., the sorbent comprising a transition metal-based sorbent, a metal-based sorbent, and the like).

The unit of any one of embodiments 31-41, further comprising:
an inlet configured to deliver the sorbent to an interior of reactor and
an outlet configured to remove spent sorbent from the interior.

The unit of any one of embodiments 31-42, wherein the first syngas stream comprises raw syngas, a char-converted product gas (e.g., a carbon trim cell product gas), an improved syngas stream (e.g., having decreased chlorine content and decreased sulfur content, as compared to raw syngas), or a combination thereof.

The unit of any one of embodiments 31-43, wherein the conditioned syngas stream comprises increased hydrogen (H₂) content and/or increased carbon monoxide (CO) content, as compared to the first syngas stream.

The unit of any one of embodiments 31-44, wherein the conditioned syngas stream further comprises decreased nitrogen content and/or decreased sulfur content, as compared to the first syngas stream.

Embodiment 46 is an integrated system comprising:
a feedstock delivery system configured to inject feedstock;
a product gas generation system configured to receive the feedstock and to yield an initial syngas stream (e.g., by way of steam reforming and/or char converting);
a warm gas clean up and catalytic hydrocarbon reforming system configured to receive the initial syngas stream and yield a conditioned syngas gas stream;
a primary gas clean up system configured to receive the conditioned syngas stream and to yield a cleaned syngas stream;
   a compression system configured to receive the cleaned syngas stream and to yield a compressed stream; and
   a secondary gas clean up system configured to receive the compressed stream and to yield a carbon dioxide-depleted stream and a carbon dioxide stream;
a synthesis system configured to receive the carbon dioxide-depleted stream and to yield a synthesis product stream comprising one or more synthesis products (e.g., one or more Fischer-Tropsch products, tail gas, etc.); and
   an upgrading system configured to receive the synthesis product stream and to yield an upgraded product stream comprising one or more upgraded products (e.g., liquid fuels, naphtha, off gas, etc.),
   optionally wherein at least one synthesis product, at least one upgraded product, or a combination of any of these is delivered to the warm gas clean up and catalytic hydrocarbon reforming system as a fuel.

The integrated system of embodiment 46, wherein the warm gas clean up and catalytic hydrocarbon reforming system comprises:
a capture unit configured to receive the initial syngas stream and yield an improved syngas stream having decreased chlorine content and/or decreased sulfur content, as compared to the initial syngas stream; and
a catalytic hydrocarbon reforming unit configured to receive the improved syngas stream and yield the conditioned syngas stream.

The integrated system of embodiment 47, wherein the product gas generation system comprises a steam reformer configured to receive the feedstock and to yield a raw syngas stream as the initial syngas stream, or a portion thereof.

The integrated system of embodiment 48, wherein the product gas generation system comprises a carbon trim cell configured to receive the raw syngas stream, or a portion thereof, and to yield a char-converted product gas as the initial syngas stream, or a portion thereof.

The integrated system of embodiment 49, wherein the capture unit is configured to receive the raw syngas stream, or a portion thereof, and the char-converted product gas, or a portion thereof.

The integrated system of embodiment 49, wherein the capture unit is configured to receive the raw syngas stream, or a portion thereof; and wherein the primary gas clean up system is configured to receive the char-converted product gas, or a portion thereof.

The integrated system of embodiment 49, wherein the capture unit is configured to receive the raw syngas stream, or a portion thereof; and wherein the catalytic hydrocarbon reforming unit is configured to receive the char-converted product gas, or a portion thereof.

The integrated system of any one of embodiments 46-52, wherein the warm gas clean up and catalytic hydrocarbon reforming system comprises a system of any one of embodiments 1-30.

The integrated system of any one of embodiments 47-52, wherein the catalytic hydrocarbon reforming unit comprises a unit of any one of embodiments 31-45.

The integrated system of any one of embodiments 46-54, wherein the initial syngas stream comprises raw syngas, a char-converted product gas (e.g., a carbon trim cell product gas), or a combination thereof.

The integrated system of any one of embodiments 46-55, wherein the conditioned syngas stream comprises increased hydrogen (H₂) content and/or increased carbon monoxide (CO) content, as compared to the initial syngas stream.

The integrated system of any one of embodiments 46-56, wherein the conditioned syngas stream further comprises decreased chlorine content, decreased sulfur content, and/or decreased nitrogen content, as compared to the initial syngas stream.

Embodiment 58 is a method of processing a syngas, the method comprising:
providing a system of any one of embodiments 1-30 or 46-57;
capturing one or more contaminants in an initial syngas stream, or a portion thereof, to yield an improved syngas stream having decreased chlorine content and/or decreased sulfur content, as compared to the initial syngas stream; and
catalytically reforming one or more of tar and hydrocarbons in the improved syngas stream, or a portion thereof, and yield a conditioned syngas stream.

Embodiment 59 is a method of processing a syngas, the method comprising:
providing the catalytic hydrocarbon reforming unit of any one of embodiments 31-45; and
catalytically reforming one or more of tar and hydrocarbons in a first syngas stream, or a portion thereof, and yield a conditioned syngas stream.

The method of embodiment 59, wherein said catalytically reforming comprises:
contacting the first syngas stream, or a portion thereof, with at least one of the one or more catalytic elements to form the conditioned syngas stream; and
controlling supply of a regeneration fluid to the at least one catalytic element.

Further additional embodiments are described below.

Embodiment 1 is a system comprising:
a gasifier configured to provide an initial syngas stream;
a conditioning unit configured to receive the initial syngas stream, or a portion thereof, and yield an improved syngas stream having decreased chlorine content and/or decreased organic sulfur and/or organic nitrogen content, as compared to the initial syngas stream; and
a catalytic hydrocarbon reforming unit configured to receive the improved syngas stream, or a portion thereof, and yield a conditioned syngas stream.

The system of embodiment 1, wherein the gasifier comprises a single stage gasifier or a multi-stage gasifier (e.g., a two-stage gasifier).

The system of embodiment 1 or 2, wherein the conditioning unit comprises a fixed bed, a fluidized bed (e.g., an indirectly heated or cooled fluidized bed with an optional internal cyclone), or a flow reactor (e.g., an entrained flow reactor with an optional cyclone).

The system of any one of embodiments 1-3, wherein the conditioning unit further comprises a first catalyst with an optional engineered particle (e.g., an alumina bubble, a ceramic bubble, a ceramic sphere, a titanate particle, silica sand, lime, dolomite, olivine sand, and the like).

The system of embodiment 4, wherein a fluidized bed material for the conditioning unit comprises the first catalyst, an engineered particle, a first sorbent (e.g., a sodium-based sorbent, a transition metal-based sorbent, and the like), or a combination of any of these.

The system of any one of embodiments 1-5, wherein the conditioning unit comprises one or more catalysts and a first sorbent to capture chlorine species and to convert organic sulfur species and/or organic nitrogen species.

The system of embodiment 6, wherein the conditioning unit further comprises an inlet configured to deliver the first sorbent to an interior of a reactor of the capture unit and an outlet configured to remove a first spent sorbent from the interior.

The system of any one of embodiments 1-7, wherein the conditioning unit is configured to operate at a temperature from about 500° C. to about 750° C.

The system of any one of embodiments 1-8, wherein the catalytic hydrocarbon reforming unit comprises a fluidized bed (e.g., an indirectly heated fluidized bed with an optional internal cyclone).

The system of any one of embodiments 1-9, wherein the catalytic hydrocarbon reforming further comprises an engineered particle (e.g., an alumina bubble, a ceramic bubble, a ceramic sphere, a titanate particle, silica sand, lime, dolomite, olivine sand, and the like).

The system of embodiment 10, wherein a fluidized bed material for the catalytic hydrocarbon reforming unit comprises the engineered particle, a second sorbent (e.g., a transition metal-based sorbent, a metal-based sorbent, and the like), or a combination of any of these.

The system of any one of embodiments 1-11, wherein the catalytic hydrocarbon reforming unit comprises one or more catalytic elements configured to crack and/or reform tar or hydrocarbon in the improved syngas stream to yield hydrogen (H₂) and/or carbon monoxide (CO).

The system of embodiment 12, wherein at least one of the one or more catalytic elements comprises:
a structure configured to allow a regeneration fluid to pass therethrough;
at least one catalyst supported on a portion of an external surface of the structure;
one or more internal channels configured to deliver the regeneration fluid to the external surface of the structure to regenerate the at least one catalyst.

The system of embodiment 13, wherein the at least one catalytic element is configured to contact the improved syngas stream to yield the conditioned syngas stream.

The system of embodiment 13 or 14, wherein the structure comprises an elongated tube.

The system of any one of embodiments 13-15, wherein the structure comprises a porous material.

The system of any one of embodiments 13-16, further comprising a manifold in fluidic communication with the one or more catalytic elements, and wherein the manifold is configured to receive the regeneration fluid and deliver the regeneration fluid to the one or more catalytic elements.

The system of any one of embodiments 13-17, wherein the regeneration fluid comprises a vapor or a gas.

The system of any one of embodiments 13-18, wherein the regeneration fluid comprises an oxidant (e.g., oxygen, steam, air, carbon dioxide, or a combination of any of these).

The system of any one of embodiment 1-19, wherein the catalytic hydrocarbon reforming unit is configured to operate at a temperature from about 700° C. to about 900° C.

The system of any one of embodiment 1-20, further comprising a pulse heater (e.g., a pulse combustion heat exchanger), an electric heater, or a heat exchanger configured to heat (e.g., indirectly heat) the catalytic hydrocarbon reforming unit or a portion thereof (e.g., a reactor of the catalytic hydrocarbon reforming unit).

The system of any one of embodiment 1-21, further comprising an oxidant source (e.g., oxygen-containing gas, such as oxygen gas (O₂)) configured to be delivered to the catalytic hydrocarbon reforming unit or a portion thereof (e.g., a reactor of the catalytic hydrocarbon reforming unit).

The system of embodiment 22, wherein the catalytic hydrocarbon reforming unit further comprises an inlet configured to deliver a second sorbent to an interior of the catalytic hydrocarbon reforming unit and an outlet configured to remove a second spent sorbent from the interior.

The system of any one of embodiments 1-23, further comprising:

a heat exchanger configured to preheat the improved syngas and/or to recover heat from the conditioned syngas.

The system of any one of embodiments 1-24, wherein the initial syngas stream comprises raw syngas, a char-converted product gas (e.g., a carbon trim cell product gas), or a combination thereof.

The system of any one of embodiments 1-25, wherein the improved syngas stream comprises decreased chlorine content and/or decreased organic sulfur and/or organic nitrogen content, as compared to the initial syngas stream.

The system of any one of embodiments 1-26, wherein the conditioned syngas stream comprises increased hydrogen (H₂) content and/or increased carbon monoxide (CO) content, as compared to the initial syngas stream.

The system of any one of embodiments 1-27, wherein the conditioned syngas stream further comprises decreased sulfur content, as compared to the initial syngas stream or the improved syngas stream.

Embodiment 31 is a catalytic hydrocarbon reforming unit comprising:
a reactor (e.g., a fluidized bed reactor) configured to receive an improved syngas stream (e.g., from a conditioning unit, such as any described herein, or a heat exchanger);
an optional cyclone disposed within an interior of the reactor; a sorbent disposed within an interior of the reactor; and
one or more catalytic elements configured to contact the first syngas stream, or a portion thereof, to yield a conditioned syngas stream, wherein at least one of the one or more catalytic elements comprises:
a structure configured to allow a regeneration fluid to pass therethrough; at least one catalyst supported on a portion of an external surface of the
structure; and
one or more internal channels configured to deliver the regeneration fluid to the external surface of the structure to regenerate the at least one catalyst.

The unit of embodiment 31, wherein the at least one catalytic element is configured to contact the first syngas stream, or a portion thereof, to yield the conditioned syngas stream.

The unit of embodiment 31 or 32, wherein the structure comprises an elongated tube.

The unit of any one of embodiments 31-33, wherein the structure comprises a porous material.

The unit of any one of embodiments 31-34, further comprising:
a manifold in fluidic communication with the one or more catalytic elements, and wherein the manifold is configured to receive the regeneration fluid and deliver the regeneration fluid to the one or more catalytic elements.

The unit of any one of embodiments 31-35, wherein the regeneration fluid comprises a vapor or a gas.

The unit of any one of embodiments 31-36, wherein the regeneration fluid comprises an oxidant (e.g., oxygen, steam, air, carbon dioxide, or a combination of any of these).

The unit of any one of embodiments 31-37, wherein the catalytic hydrocarbon reforming unit is configured to operate at a temperature from about 700° C. to about 900° C.

The unit of any one of embodiments 31-38, further comprising:
a pulse heater (e.g., a pulse combustion heat exchanger), an electric heater, or a heat exchanger configured to heat (e.g., indirectly heat) the catalytic hydrocarbon reforming unit or a portion thereof (e.g., the reactor of the catalytic hydrocarbon reforming unit).

The unit of any one of embodiments 31-39, further comprising:
an inlet configured to deliver an oxidant source (e.g., oxygen-containing gas, such as oxygen gas (O₂)) to the catalytic hydrocarbon reforming unit or a portion thereof (e.g., the reactor of the catalytic hydrocarbon reforming unit).

The unit of any one of embodiments 31-40, wherein the sorbent is configured to capture sulfur species (e.g., the sorbent comprising a transition metal-based sorbent, a metal-based sorbent, and the like).

The unit of any one of embodiments 31-41, further comprising:
an inlet configured to deliver the sorbent to an interior of reactor and an outlet configured to remove spent sorbent from the interior.

The unit of any one of embodiments 31-42, wherein the improved syngas stream, has decreased chlorine content and and/or decreased organic sulfur and/or organic nitrogen content, as compared to raw syngas.

The unit of any one of embodiments 31-43, wherein the conditioned syngas stream comprises increased hydrogen (H₂) content and/or increased carbon monoxide (CO) content, as compared to the first syngas stream.

The unit of any one of embodiments 31-44, wherein the conditioned syngas stream further comprises decreased chlorine and sulfur content, as compared to the first syngas stream.

Embodiment 46 is an integrated system comprising:
a feedstock delivery system configured to inject feedstock;
   a product gas generation system configured to receive the feedstock and to yield an initial syngas stream (e.g., by way of steam reforming and/or char converting);
   a warm gas clean up and catalytic hydrocarbon reforming system configured to receive the initial syngas stream and yield a conditioned syngas gas stream;
   a primary gas clean up system configured to receive the conditioned syngas stream and to yield a cleaned syngas stream;
   a compression system configured to receive the cleaned syngas stream and to yield a compressed stream; and
   a secondary gas clean up system configured to receive the compressed stream and to yield a carbon dioxide-depleted stream and a carbon dioxide stream;
   a synthesis system configured to receive the carbon dioxide-depleted stream and to yield a synthesis product stream comprising one or more synthesis products (e.g., one or more Fischer-Tropsch products, tail gas, etc.); and
   an upgrading system configured to receive the synthesis product stream and to yield an upgraded product stream comprising one or more upgraded products (e.g., liquid fuels, naphtha, off gas, etc.),
optionally wherein at least one synthesis product, at least one upgraded product,
or a combination of any of these is delivered to the warm gas clean up and catalytic hydrocarbon reforming system either for conditioning or as a fuel or both.

The integrated system of embodiment 46, wherein the warm gas clean up and catalytic hydrocarbon reforming system comprises:
a conditioning unit configured to receive the initial syngas stream and yield an improved syngas stream having decreased chlorine content and/or decreased organic sulfur and/or organic nitrogen content, as compared to the initial syngas stream; and
a catalytic hydrocarbon reforming unit configured to receive the improved syngas stream and yield the conditioned syngas stream.

The integrated system of embodiment 47, wherein the product gas generation system comprises a steam reformer configured to receive the feedstock and to yield a raw syngas stream as the initial syngas stream, or a portion thereof.

The integrated system of embodiment 48, wherein the product gas generation system comprises a carbon trim cell configured to receive the raw syngas stream, or a portion thereof, and to yield a char-converted product gas as the initial syngas stream, or a portion thereof.

The integrated system of embodiment 49, wherein the conditioning unit is configured to receive the raw syngas stream, or a portion thereof, and the char-converted product gas, or a portion thereof.

The integrated system of embodiment 49, wherein the conditioning unit is configured to receive the raw syngas stream, or a portion thereof; and wherein the primary gas clean up system is configured to receive the char-converted product gas, or a portion thereof.

The integrated system of embodiment 49, wherein the conditioning unit is configured to receive the raw syngas stream, or a portion thereof; and wherein the catalytic hydrocarbon reforming unit is configured to receive the char-converted product gas, or a portion thereof.

The integrated system of any one of embodiments 46-52, wherein the warm gas clean up and catalytic hydrocarbon reforming system comprises a system of any one of embodiments 1-30.

The integrated system of any one of embodiments 47-52, wherein the catalytic hydrocarbon reforming unit comprises a unit of any one of embodiments 31-45.

The integrated system of any one of embodiments 46-54, wherein the initial syngas stream comprises raw syngas, a char-converted product gas (e.g., a carbon trim cell product gas), or a combination thereof.

The integrated system of any one of embodiments 46-55, wherein the conditioned syngas stream comprises increased hydrogen (H₂) content and/or increased carbon monoxide (CO) content, as compared to the initial syngas stream.

The integrated system of any one of embodiments 46-56, wherein the conditioned syngas stream further comprises decreased chlorine content, decreased sulfur content, and/or decreased organic nitrogen content, as compared to the initial syngas stream.

Embodiment 58 is a method of processing a syngas, the method comprising:
providing a system of any one of embodiments 1-30 or 46-57;
   capturing one or more contaminants in an initial syngas stream, or a portion thereof, to yield an improved syngas stream having decreased chlorine content and/or decreased sulfur content, as compared to the initial syngas stream; and
   catalytically reforming one or more of tar and hydrocarbons in the improved syngas stream, or a portion thereof, and yield a conditioned syngas stream.

Embodiment 59 is a method of processing a syngas, the method comprising:
providing the catalytic hydrocarbon reforming unit of any one of embodiments 31-45; and
   catalytically reforming one or more of tar and hydrocarbons in a first syngas stream, or a portion thereof, and yield a conditioned syngas stream.

The method of embodiment 59, wherein said catalytically reforming comprises:
contacting the first syngas stream, or a portion thereof, with at least one of the one or more catalytic elements to form the conditioned syngas stream; and
controlling supply of a regeneration fluid to the at least one catalytic element.

Embodiment 61 is an integrated system comprising:
a feedstock delivery system configured to inject feedstock;
a product gas generation system configured to receive the feedstock and to yield an initial syngas stream (e.g., by way of steam reforming and/or char converting);
a warm gas clean up and catalytic hydrocarbon reforming system configured to receive the initial syngas stream and yield a conditioned syngas gas stream;
a primary gas clean up system configured to receive the conditioned syngas stream and to yield a cleaned, carbon dioxide-depleted syngas stream and a carbon dioxide stream;
a compression system configured to receive the cleaned syngas stream and to yield a compressed stream; and
a secondary gas clean up system configured to receive the compressed stream and to yield a polished syngas stream;
a synthesis system configured to receive the polished syngas stream and to yield a synthesis product stream comprising one or more synthesis products (e.g., one or more Fischer-Tropsch products, tail gas, etc.); and
an upgrading system configured to receive the synthesis product stream and to yield an upgraded product stream comprising one or more upgraded products (e.g., liquid fuels, naphtha, off gas, etc.), optionally wherein at least one synthesis product, at least one upgraded product, or a combination of any of these is delivered to the warm gas clean up and catalytic hydrocarbon reforming system either for conditioning or as a fuel or both.

Embodiment 62 is an integrated system comprising:
a feedstock delivery system configured to inject feedstock;
   a product gas generation system configured to receive the feedstock and to yield an initial syngas stream (e.g., by way of steam reforming and/or char converting);
   a warm gas clean up and catalytic hydrocarbon reforming system configured to receive the initial syngas stream and yield a conditioned syngas gas stream;
   a primary gas clean up system, a compression system, and a secondary gas clean up system configured to receive the conditioned syngas stream and to yield a polished, clean, carbon dioxide-depleted syngas stream and a carbon dioxide stream;
   a synthesis reactor train or separation system configured to receive the polished syngas stream and to yield a liquid fuel or chemical or hydrogen; and
   part of the carbon dioxide is recycled.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A system comprising:
a gasifier configured to provide an initial syngas stream;
a capture unit configured to receive the initial syngas stream, or a portion thereof, and yield an improved syngas stream having decreased chlorine content decreased organic sulfur and/or organic nitrogen content, as compared to the initial syngas stream; and
a catalytic hydrocarbon reforming unit configured to receive the improved syngas stream, or a portion thereof, and yield a conditioned syngas stream.

2. The system of claim 1, wherein the gasifier comprises a single stage gasifier or a multi-stage gasifier.

3. The system of claim 1, wherein the capture unit comprises a fixed bed, a fluidized bed, or a flow reactor.

4. The system of claim 1, wherein the capture unit further comprises a first catalyst with an optional engineered particle.

5. The system of claim 4, wherein a fluidized bed material for the capture unit comprises the first catalyst, an engineered particle, a first sorbent, or a combination of any of these.

6. The system of claim 1, wherein the capture unit comprises a first sorbent to capture chlorine species and/or sulfur species.

7. The system of claim 6, wherein the capture unit further comprises an inlet configured to deliver the first sorbent to an interior of a reactor of the capture unit and an outlet configured to remove a first spent sorbent from the interior.

8. The system of claim 1, wherein the capture unit is configured to operate at a temperature from about 500° C. to about 750° C.

9. The system of claim 1, wherein the catalytic hydrocarbon reforming unit comprises a fluidized bed.

10. The system of claim 1, wherein the catalytic hydrocarbon reforming further comprises an engineered particle.

11. The system of claim 10, wherein a fluidized bed material for the catalytic hydrocarbon reforming unit comprises the engineered particle, a second sorbent, or a combination of any of these.

12. The system of claim 1, wherein the catalytic hydrocarbon reforming unit comprises one or more catalytic elements configured to crack and/or reform tar or hydrocarbon in the improved syngas stream to yield hydrogen (H₂) and/or carbon monoxide (CO).

13. The system of claim 12, wherein at least one of the one or more catalytic elements comprises:
a structure configured to allow a regeneration fluid to pass therethrough;
at least one catalyst supported on a portion of an external surface of the structure; and
one or more internal channels configured to deliver the regeneration fluid to the external surface of the structure to regenerate the at least one catalyst.

14. The system of claim 13, wherein the at least one catalytic element is configured to contact the improved syngas stream to yield the conditioned syngas stream.

15. The system of claim 13, wherein the structure comprises an elongated tube.

16. The system of claim 13, wherein the structure comprises a porous material.

17. The system of claim 13, further comprising a manifold in fluidic communication with the one or more catalytic elements, and wherein the manifold is configured to receive the regeneration fluid and deliver the regeneration fluid to the one or more catalytic elements.

18. The system of claim 13, wherein the regeneration fluid comprises a vapor or a gas.

19. The system of claim 13, wherein the regeneration fluid comprises an oxidant.

20. The system of claim 1, wherein the catalytic hydrocarbon reforming unit is configured to operate at a temperature from about 700° C. to about 900° C.
